(19) United States
(12) Patent Application Publication
(10) Pub. No.: US 2024/0273464 A1
(43) Pub. Date: Aug. 15, 2024

(54) SYSTEM, DEVICE AND METHOD FOR REDUCING WASTE IN A RETAIL STORE

(71) Applicant: WHYWASTE AB, Göteborg (SE)

(72) Inventor: Kristoffer HAGSTEDT, Göteborg (SE)

(21) Appl. No.: 18/566,031

(22) PCT Filed: May 30, 2022
(86) PCT No.: PCT/SE2022/050520

§ 371 Date: Nov. 30, 2023

(30) Foreign Application Priority Data
May 31, 2021 (SE) 2150691-0

(51) Int. Cl. G06Q 10/087

(52) U.S. Cl. CPC G06Q 10/087

(57) ABSTRACT

The present disclosure relates to a computer-implemented method (100) for reducing waste in a retail store, the method comprising the steps of obtaining (101) inventory-data of a plurality of products in a retail store, each product being associated with an expiration period below a threshold. Further, determining (102) a priority scheme for said plurality of products. Further, the method determines (103) at least one product from said priority scheme having a highest priority order. Moreover, the method provides (104) information to a display entity located in said retail store to display graphics emphasizing said at least one product from said priority scheme having the highest priority order. Furthermore, the method updates (105) the priority scheme upon receiving, point-of-sale, POS, data associated with the plurality of products, from a POS terminal.

### TECHNICAL FIELD

The present disclosure relates to a system, optimization device and method for reducing waste in a retail store.

### BACKGROUND ART

One of the main problems in grocery stores are the massive amounts of products that are wasted on a daily basis. One of the main reasons for the product waste is that products have passed their expiration date without being sold. Thus, the products where the expiration date has passed are discarded. Consequently, this results in environmental and monetary loss.

In grocery stores today, there is a lot of time spent on monitoring the expiration dates of products in order to be able to take action to prevent the expiration date to pass. A common action is to reduce the price of the products in order to give incentives to customers to purchase the products to prevent waste.

However, even though the assigning of discount prices to products work well in some situations, still, a large amount of products remain unsold and ends up as waste. A reason for this is that customers fail to acknowledge that the products are discounted, leading to that they won't take part of the offer and the products will eventually be wasted. Another reason for the products ending up as waste is that the discount prices are usually assigned in a passive manner mainly based on the upcoming expiration date without contemplating other relevant factors which can affect the products chance of getting sold.

There is no solutions in the market today for efficiently reducing waste in a retail store.

Accordingly, there is room for systems and methods to explore the domain of providing improved systems, devices and methods to reduce the waste in retail stores. More specifically, there is a need for systems and methods to explore the domain of providing improved systems and methods that proactively identifies products with risk of becoming waste, and based on this continuously operates to prevent those products from becoming waste.

Thus, it would be desirable to provide improved methods and systems that fulfils requirements related to reducing waste in retail stores in order to prevent environmental and monetary loss.

### SUMMARY OF THE INVENTION

It is therefore an object of the present disclosure to provide a system, device, method, computer program and carrier to mitigate, alleviate or eliminate one or more of the above-identified deficiencies and disadvantages.

This object is achieved by means of a method for reducing waste and a system, device, computer program and carrier for the same as defined in the appended claims 1, 8, 9 and 10, 11.

The present disclosure provides a computer-implemented method for reducing waste in a retail store. The method comprises the step of obtaining inventory-data of a plurality of products in a retail store, each product being associated with an expiration period below a threshold. Further, the method comprises the step of determining a priority scheme for said plurality of products, the priority scheme being based upon at least one parameter. Moreover, the method comprises the step of determining at least one product from said priority scheme having a highest priority order. Further, the method comprises the step of providing information to control a display entity located in said retail store to display graphics emphasizing said at least one product from said priority scheme having the highest priority order. Furthermore, the method updates the priority scheme upon receiving, point-of-sale (POS) data associated with the plurality of products, from a POS terminal.

An advantage of the method as described above is that it proactively identifies products that are to be prioritized in order to minimize waste in a retail store. Further, by updating the priority scheme based on POS data, the method may transmit control signals to adapt the display entity to shift focus to other products based on altered inventory levels. By being able to adapt the display entity continuously in such a manner, an optimized waste minimization in the retail store is achieved. Thus, the method allows for a proactive and adaptable waste minimization taking into account real-time inventory alterations. Furthermore, by combining the display entity with the priority scheme, products that are identified as ‘high priority order’-products may be exposed to more potential buyers of said product which in turn leads to a higher chance of said product avoiding to become waste. Thus, preventing that products that sell less than expected passes their expiration date.

The plurality of products may each have a pre-assigned identity. Thus, each product of said plurality of products may be associated with an expiration period and an identity. Identity may be e.g. a category of a product, a product sort, or a combination thereof.

The at least one parameter may comprise one or more retail-store related parameters and/or one or more product-related parameters. The retail-store related parameters may comprises at least one of weather data, customer traffic or opening-hours. Further, the product-related parameters may comprise at least one of a sales forecast, price, discount, sales history data, price-elasticity and remaining inventory quantity of each product.

Thus, the method may determine the priority scheme based on said parameters, allowing the method to reduce waste in a retail store based on one or a plurality of parameters. Thus, by taking at least one of the parameters into account the method may determine specific products that should be emphasized on the display entity to facilitate a reduced waste.

In some embodiments, the at least one parameter is a plurality of parameters. Further, the priority scheme may be directed to prioritize products that, given the at least one parameter and the products expiration period, will have a greater chance of being reduced from the inventory, thus the method may strive to reduce waste in absolute measures.

It should be noted that the waste reduction strived for within the context of the present disclosure may be waste reduction in terms of carbon footprint, weight of products, monetary waste reduction, number of product units, waste reduction to minimize environmental impact, or any combination thereof. Thus, the disclosure may aim to reduce waste from different viewpoints, preferably, involving several viewpoints.

The step of determining at least one product from said priority scheme having a highest priority order may be based upon an additional-sales forecast parameter determined for each product. The additional-sales forecast parameter determines an additional sales expected from a product, by having said product being graphically emphasized on said display entity during a time period.

Thus, the method may determine products that will according to the additional-sales forecast parameter gain an additional sales from being displayed, and based on this determine products that should be displayed. It should be noted that the priority scheme is preferably based on the additional-sales forecast parameter and also one or more retail-store related parameters and/or one or more product-related parameters in combination with the additional-sales forecast parameter.

A benefit of this is that the method determines the additional sales that can be expected by displaying products on said display entity. Thus, the method may e.g. deprioritize products that are not expected to be gaining additional-sales by being displayed and prioritizing products that may be subject to a higher additional sales with respect to waste minimization.

The method may further comprise the step of assigning discount prices to at least one of said plurality of products, the discount prices being based on a remaining expiration period, an amount of products remaining, a price elasticity of a product, forecasted future demand or any combination thereof. The step of assigning may also refer to assigning discount prices to already discounted products. In other words, the products may be further reduced in price. Accordingly, the step of assigning may be iteratively performed.

A benefit of this is that the discount prices may boost the sales of the products and further reduce the waste in the retail store.

The at least one parameter may be selected by means of a trained learning algorithm configured to reduce waste in said retail store, wherein the step of determining the priority scheme comprises, determining, by means of the trained learning algorithm, the priority scheme for said plurality of products based on the at least one selected parameter. Further, the step of determining the at least one product comprises, determining, by means of the trained learning algorithm, the at least one product from said priority scheme having the highest priority order.

A benefit of this is that the trained learning algorithm may determine the priority scheme and the products in the priority scheme having the highest priority order in order to minimize the waste in the retail store. Accordingly, the method provides the benefit of, given any inventory-data, maximizing waste reduction in the retail store, by exposing it to potential customers in a calculated manner to reduce waste. In other words, the method minimizes waste by applying the trained learning algorithm to a given inventory data, and the at least one parameter to determine products that should be displayed on the display entity in order to reduce waste in the retail store by maximizing the sales of the products with an expiration date below a specific threshold.

The method may also comprise the step of, upon updating the priority scheme, repeating the step of determining at least one product from said priority scheme having a highest priority order.

A benefit of this is that the method re-determines the products with a highest priority order allowing to maximize waste reduction based on a current state of the inventory data and data obtained from the POS-terminal.

The POS data may comprise quantity and identity of products sold at a point in time. In other words, the POS data may comprise data indicating identity of products sold, the point of time where the products are sold, and quantity of the products sold in said point of time. Point of time may be a specific date, a specific time or a combination thereof. The POS-data may be transmitted in time-intervals or real-time when a product is sold.

There is further disclosed a system for reducing waste in a retail store, the system comprising an optimization device comprising control circuitry, a memory device, an input interface and an output interface, a display entity located in said retail store, and a point-of-sale, POS terminal. The optimization device is configured to obtain inventory-data of a plurality of products in a retail store, each product being associated with an expiration period below a threshold. Further the optimization device is configured to determine a priority scheme for said plurality of products, the priority scheme being based upon at least one parameter and determine at least one product from said priority scheme having a highest priority order. Moreover, the system is configured to, after determining at least one product from said priority scheme having a highest priority order: display, at said display entity located in said retail store, graphics emphasizing said at least one product from said priority scheme having the highest priority order, and update the priority scheme upon receiving, point-of-sale, POS, data associated with the plurality of products, from said POS terminal.

There is further disclosed an optimization device for reducing waste in a retail store, wherein the optimization device comprises control circuitry, a memory device, an input interface and an output interface, wherein the optimization device is arranged to be connected to a display entity located in said retail store, and a point-of-sale (POS) terminal. The optimization device is configured to obtain inventory-data of a plurality of products in a retail store, each product being associated with an expiration period below a threshold. Further, the optimization device is configured to determine a priority scheme for said plurality of products, the priority scheme being based upon at least one parameter. Further, the optimization device is configured to determine at least one product from said priority scheme having a highest priority order. Furthermore, the optimization device is configured to provide information to a display entity located in said retail store to display graphics emphasizing said at least one product from said priority scheme having the highest priority order and update the priority scheme upon receiving, point-of-sale, POS data associated with the plurality of products, from said POS terminal.

There is further disclosed a computer program, comprising instructions which, when executed on at least one control circuitry, cause the at least one control circuitry to carry out the computer-implemented method according to the disclosure herein.

There is further disclosed a carrier containing the computer program according to the disclosure herein, the carrier is one of an electronic signal, optical signal, radio signal or computer readable storage medium.

### BRIEF DESCRIPTION OF THE DRAWINGS

In the following the disclosure will be described in a non-limiting way and in more detail with reference to exemplary embodiments illustrated in the enclosed drawings, in which:

FIG. 1 illustrates a flowchart of a method, in accordance with an embodiment of the present disclosure;

FIG. 2 illustrates an exemplary flowchart of a part of the method shown in FIG. 1;

FIG. 3 schematically illustrates a system in accordance with an embodiment of the present disclosure;

FIG. 4 schematically illustrates an optimization device in accordance with an embodiment of the present disclosure;

### DETAILED DESCRIPTION

In the following detailed description, some embodiments of the present disclosure will be described. However, it is to be understood that features of the different embodiments are exchangeable between the embodiments and may be combined in different ways, unless anything else is specifically indicated. Even though in the following description, numerous specific details are set forth to provide a more thorough understanding of the provided system and method, it will be apparent to one skilled in the art that the system and method may be realized without these details. In other instances, well known constructions or functions are not described in detail, so as not to obscure the present disclosure.

In the following description of example embodiments, the same reference numerals denote the same or similar components.

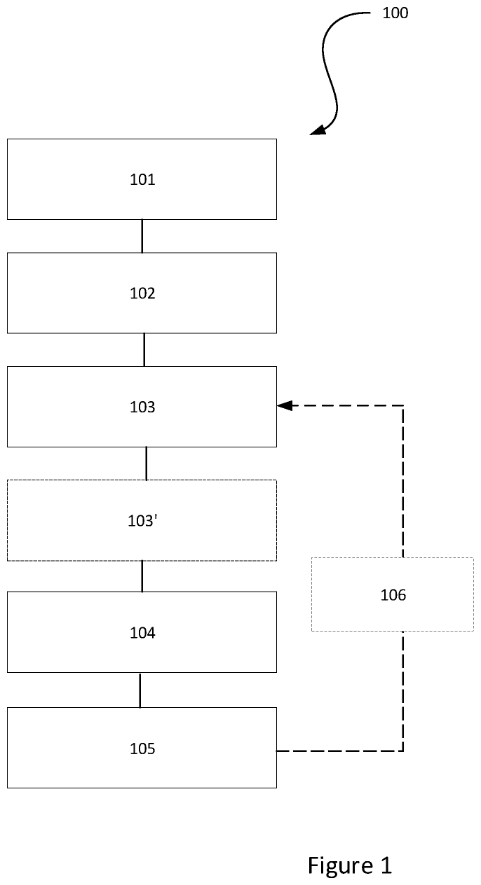

FIG. 1 illustrates a flowchart of a method for reducing waste in a retail store, the method comprising the steps of obtaining 101 inventory-data of a plurality of products in a retail store, each product being associated with an expiration period below a threshold. Further comprising the step of determining 102 a priority scheme for said plurality of products, the priority scheme being based upon at least one parameter. Further, the method 100 comprises the step of determining 103 at least one product from said priority scheme having a highest priority order. Further, the method 100 comprises the step of providing 104 information to a display entity located in said retail store to display graphics emphasizing (or information relating to) said at least one product from said priority scheme having the highest priority order. Moreover, the method updates 105 the priority scheme upon receiving, point-of-sale (POS) data associated with the plurality of products, from a POS terminal. By providing a priority scheme for products with expiration periods below a threshold, the method is allowed to optimize sales on products that could be wasted, thereby the method is specifically directed to reduce waste in a specific retail store. Thus, the method may in some aspects only process products with specific remaining expiration periods below a threshold.

Accordingly, the method may be fully based on obtaining data of products with expiration periods below a threshold, in which the method utilizes such products in said priority scheme so to select products to reduce waste in said store. Thus, a large amount of products, not having the expiration period below a threshold may be disregarded, so to obtain a priority scheme being more efficient for reducing waste in the retail store. The information (data) may be information comprising the at least one product having a highest priority order, so to allow a display entity to display said at least one products. Additionally, the information may comprise the at least one product having a highest priority order and a display time period for each of said at least one products. In other words, the display time period may indicate, an optimal time period for the at least one product to be displayed on said display entity. Accordingly, the step of determining 103 may also determine a display time period for each of the at least one product having a highest priority order.

The number of products being chosen as having a highest priority order may be any number, preferably 1-20 products, more preferably 1-10 products, most preferably 1-5 products.

The display entity may be a plurality of display entities.

The term “point-of-sales (POS) terminal” may refer to a system for processing payment for products. For example, the POS terminal may process payments (e.g. card payments). The POS terminal may be a hardware system located in the retail store. The POS terminal may track sales data of products and track inventory changes.

The term “POS data” may refer to data comprising quantity and identity of products sold at a point in time.

The term “priority scheme” may refer to a mapping of the plurality of products that allows a product, or a category of products to be associated with a priority level which may indicate a reduced waste in the retail store—if said products are displayed on said display entity. The priority scheme may therefore rank a plurality of products with an expiration period below a threshold, thereby specifically focusing on products with e.g. outgoing expiration periods to optimize sales on said products to reduce waste. Accordingly, the priority scheme is specifically directed to map/prioritize products with specific remaining expiration periods against parameters so to reduce waste—thereby products that are subject to waste can be identified.

The term “display entity” may refer to any means that may show graphics. The display entity is preferably an electronic display entity, e.g. an LCD screen. The display entity is preferably arranged in said retail store in the most populated areas of the retail store, so to draw as much attention as possible from potential customers.

The term “expiration period” or “expiration date” may refer to a pre-determined date, e.g a last sellable date, sell-by date, guaranteed fresh date, best-if-used date, best-before date, a manually determined date (e.g. by a personnel in a store) or any other suitable date.

The at least one parameter may comprise one or more retail-store related parameters and/or one or more product-related parameters wherein the retail-store related parameters comprises at least one of weather data, customer traffic or opening-hours wherein product-related parameters comprises at least one of a sales forecast, price (i.e. product price for a specific product), discount (i.e. a current product discount being a fraction of original product price, thus discount may refer to a discounted price), sales history data, price-elasticity and remaining inventory quantity of each product. Thus, the method 100 may also further obtain or seek parameter data.

The step of determining 103 at least one product from said priority scheme having a highest priority order may be based upon an additional-sales forecast parameter determined for each product. The additional-sales forecast parameter determines an additional sales expected from a product, by having said product being graphically emphasized on said display entity during a time period.

The method 100 may further comprise the step of assigning 103′ discount prices to at least one of said plurality of products, the discount prices being based on a remaining expiration period.

Furthermore as shown in FIG. 1, the method 100 may further comprise the step of, upon updating 105 the priority scheme, repeating 106 the step of determining 103 at least one product from said priority scheme having a highest priority order.

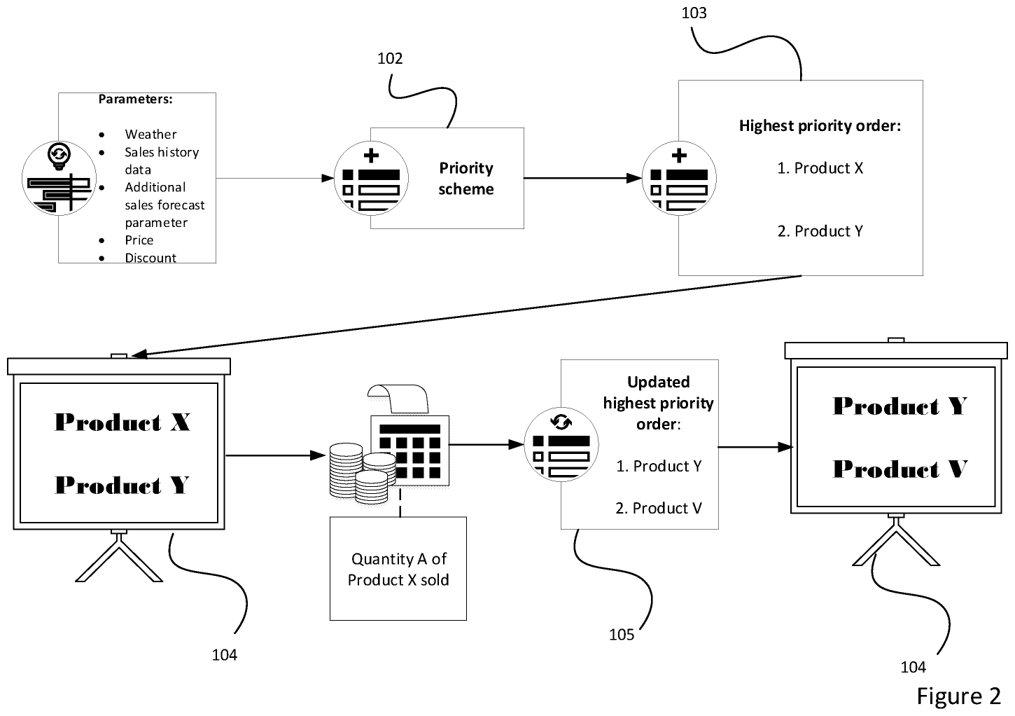

FIG. 2 serves as an exemplary illustration of the method 100, showing a flow of the method steps 102-105. The disclosure is not limited to the flow of FIG. 2 in any sense. As seen in FIG. 2, at least one parameter may be selected. In FIG. 2, the parameters are weather, sales history data, price, discount and additional sales forecast parameter. Thus, the plurality of products obtained in step 101 will be prioritized based on the selected parameters in order to maximize waste reduction. Further, it is shown in FIG. 2 that products X and Y have a highest priority order. This may indicate that for a current weather condition, combined with sales history data and an additional sales forecast parameter, if the products X and Y are displayed on said entity, the waste reduction will be maximized in said store at said point in time.

Moreover, FIG. 2 shows that a quantity of product X are sold after that the products have been displayed on said entity. Thus, in accordance with step 105 of the method, the priority scheme is updated. Consequently the highest priority order is updated and product X is no longer prioritized. Instead, new products are introduced having a highest priority order and the display entity is also updated as a consequence of this (now showing Products Y and V).

The at least one parameter may be selected by means of a trained learning algorithm configured to reduce waste in said retail store. Further, the step of determining 102 the priority scheme may comprise, determining, by means of the trained learning algorithm, the priority scheme for said plurality of products based on the at least one selected parameter. Moreover, the step of determining 103 the at least one product may comprise, determining, by means of the trained learning algorithm, the at least one product from said priority scheme having the highest priority order.

The trained learning algorithm may operate so to process a plurality of inputs being inventory-data, POS-data, product-related parameters and retail-store related parameters and combine said inputs to determine the products that are to be displayed on said display entity in order to minimize waste.

The trained learning algorithm may comprise statistical models including covariate models, known future input models, exogenous time-series models and feedback-models. In some embodiments, the trained learning algorithm combines said models to reduce the waste in said retail store.

The covariate models may comprise static covariates, comprising:
mathematical modelling of products, for example latent space representation learned through contextual information;
approximation of various distributions (for example, time between sales- and/or waste events, related to products, socio-economic factors of the store e.g. age distributions of customers, gender distributions and any other factors.
historical sensitivity to promotional actions e.g. effects to the waste levels in the store from previously displaying a specific product at said display entity for a time period.

Further, covariate models may comprise dynamic covariates, comprising:
real-time information about inventory levels of the plurality of products, store traffic and POS-data.

Known future input models may comprise features that will affect sales, e.g. weather, promotional information, holidays etc.

Feedback models may comprise feedback loops, wherein the output of the trained learning algorithm becomes a part of the input into the learning algorithm. Resulting in a continuously improved algorithm.

Exogenous time-series models observe historical data without prior information of how they interact with the targeted outcome, for instance historical sales and waste data of said plurality of products in said retail store.

Combining said models the algorithm may implement several sources of intermediate features such as coefficients of freshness, forecasted sales and/or waste patterns, and the output of various unsupervised learning models such as embedded representations for each product and/or product category. Moreover, the trained learning algorithm may, by means of the models herein, associate the different type of inputs to a plurality of outcomes for the products, wherein the outcome that may result in a maximized waste reduction will be pursued.

Thus, the trained learning algorithm may determine said priority scheme for said plurality of products, where the products having a highest priority order will have the most impact on store waste given a current situation. It should be noted that the learning algorithm is not limited to said models. Several models may be used, depending on a state and input data, as either an end-to-end algorithm or to compute intermediate processes. These could for instance include Proximal Policy Optimization or other reinforcement learning methods, Stochastic Optimization algorithms such as Genetic programming or Evolutionary algorithms, or other deterministic classifiers may also be utilized.

The trained learning algorithm may, in other words, use a plurality of software based, computer executable machine learners to develop from sets of input at least one set of computer executable rules usable to predict at least one product having a highest priority order, wherein, upon providing information to control a display entity to display the at least one product having highest priority order, waste minimization in a retail store will be optimized and facilitated.

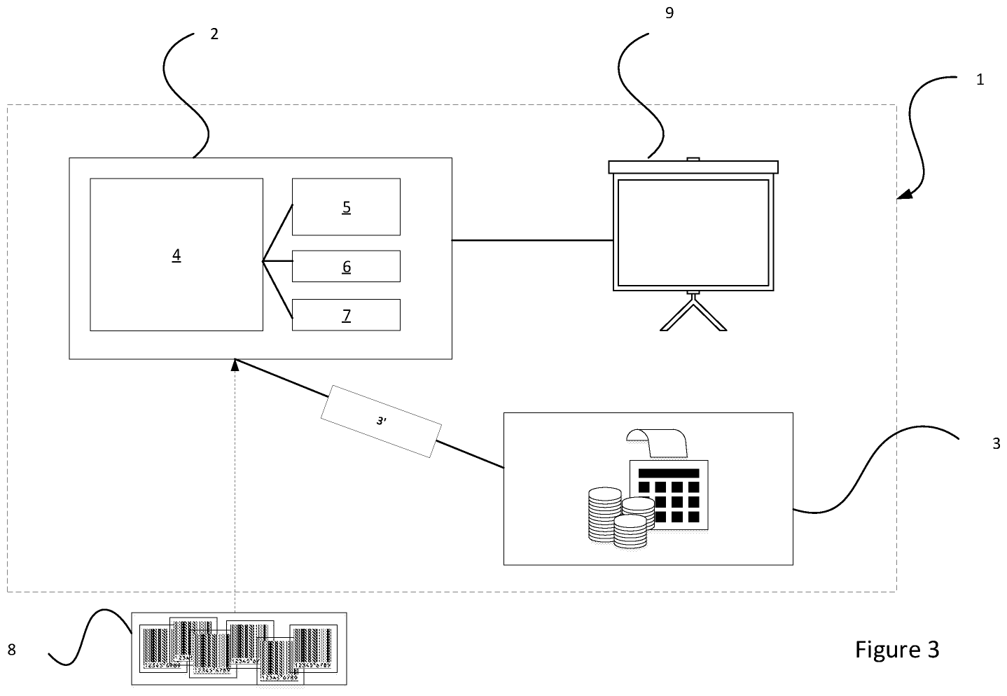

FIG. 3 schematically illustrates a system 1 for reducing waste in a retail store. The system 1 comprises an optimization device 2 comprising control circuitry 4, a memory device 5, an input interface 6, an output interface 7, a display entity 9 located in said retail store and a point-of-sale (POS) terminal 3. The system 1 may be configured to perform the method 100 in accordance with the present disclosure.

The optimization device 2 is configured to obtain inventory-data 8 of a plurality of products in a retail store, each product being associated with an expiration period below a threshold. The threshold may be a pre-determined number of days prior to the expiration period. The threshold may be different for different products. Further, the device 2 is configured to determine a priority scheme for said plurality of products, the priority scheme being based upon at least one parameter. Further, the device 2 is configured to determine at least one product from said priority scheme having a highest priority order, wherein the system 1 is configured to, after determining at least one product from said priority scheme having a highest priority order, provide information to control a display entity 9 in said retail store to display graphics emphasizing said at least one product from said priority scheme having the highest priority order and updating the priority scheme upon receiving, point-of-sale (POS) data 3′ associated with the plurality of products, from said POS terminal 3.

As illustrated in FIG. 3, the optimization device 2 may comprise one or more memory devices 5 and control circuitry 4. The memory device 5 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by each associated control circuitry 4. Each memory device 5 may store any suitable instructions, data or information, including a computer program, software, an application including one or more of logic, rules, code, tables, etc. and/or other instructions capable of being executed by the control circuitry 4 and, utilized. Memory device 5 may be used to store any calculations made by control circuitry 4 and/or any data received via output and input interface 6, 7. In some embodiments, each control circuitry 4 and each memory device 5 may be considered to be integrated. In some embodiments, the memory device 5 and related data are stored in a cloud server accessible by the optimization device 2.

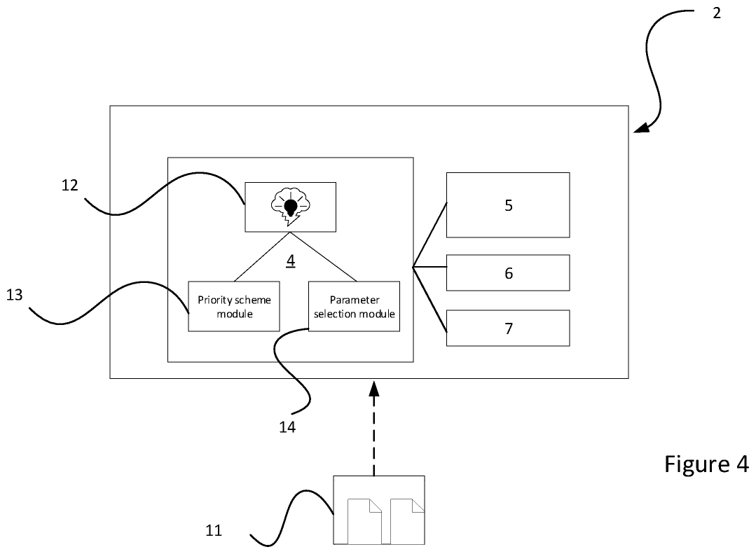

Each memory device 5 may also store data that can be retrieved, manipulated, created, or stored by the control circuitry 4. The data may include, for instance, local updates, parameters, training data, trained learning algorithms (and/or the models, components, data utilized in said trained learning algorithms), current and previous priority schemes and other data. Each memory device 5 may also store the POS data 3′, inventory data and data relating to the at least one parameter. Thus, the trained learning algorithm may be considered as such data and as shown in FIG. 3, the trained learning algorithm may be stored in the memory device 5. However, the trained learning algorithm may be stored in a cloud computing device accessible by the optimization device 2. Preferably, the control circuitry 4 comprises a machine learning component 12 that based on data from the memory device 5 may implement said trained learning algorithm (see FIG. 4). The data can be stored in one or more databases. The one or more databases can be connected to the optimization device 2 by a high bandwidth field area network (FAN) or wide area network (WAN), or can also be connected to the optimization device 2 through a communication network.

The circuitry 4 may include, for example, one or more central processing units (CPUs), graphics processing units (GPUs) dedicated to performing calculations, and/or other processing devices. The memory device 5 may comprise one or more computer-readable media and can store information accessible by the control circuitry 4, including instructions/programs that can be executed by the control circuitry 4.

The instructions which may be executed by the control circuitry 4 may comprise instructions for implementing the trained learning algorithm according to any aspects of the present disclosure. Generally, it may comprise instructions to perform any of the steps 101-105 in the method 100. For example, determining 102, 103 a priority scheme and products having a highest priority order based on any data.

The optimization device 2 may be configured to exchange data with one or more other optimization devices 2, the POS terminal 3, the display entity 9 or a remote entity or a cloud computing device over a network (not shown). Any number of optimization devices 2 may communicate over a network. Further, the optimization device 2 may be configured to, upon transmitting a control signal, update the graphics of the display entity 9.

The network may be any type of communication network, such as a local area network (e.g. intranet), wide area network (e.g. Internet), cellular network, or some combination thereof.

Communication between optimization devices 2, POS-terminals 3, display entities 9, clouds and remote entities can be carried via network interface using any type of wired and/or wireless connection, using a variety of communication protocols (e.g. TCP/IP, HTTP, SMTP, FTP), encodings or formats (e.g. HTMF, XMF), and/or protection schemes (e.g. VPN, secure HTTP, SSF).

The POS-terminal 3 may also comprise control circuitry, memory devices, input interfaces and output interfaces (not shown). Thus, the POS-terminal 3 may be configured to transmit POS-data 3′ to said optimization device. The POS-data 3′ may be transmitted via intermediate nodes. The POS-terminal 3 may comprise executable instructions to transmit POS-data 3′ in real-time to said optimization device 2 in order to perform updates to the priority scheme rapidly.

FIG. 4 schematically illustrates the optimization device 2 in more detail. As seen in FIG. 4, the optimization device 2 may receive data 11 comprising parameter-data, inventory-data, POS-data or any other data.

Further, FIG. 4 illustrates that the control circuitry 4 of the optimization device 2 comprises a machine learning component 12. The machine learning component 12 may comprise the trained learning algorithm according to any aspect of the present disclosure. Further, the control circuitry 4 may comprise a priority scheme module 13 and a parameter selection module 14. Accordingly, based on the received data 11 (which may be stored in the memory device 5), the machine learning component 12 may derive in said priority scheme module 13 a priority scheme (e.g. in accordance with step 102 of the method 100) being optimized in terms of waste reduction in said retail store. Furthermore, the machine learning component 12 may derive in said parameter selection module 14, the sufficient parameter that are to be utilized/used when, by means of the trained learning algorithm, determining the priority scheme. Further, the machine learning component 12 may determine products in said priority scheme having a highest priority order (in accordance with step 103 of the method 100).

The optimization device 2, is arranged to be connected to a display entity 9 located in said retail store, and a point-of-sale, POS terminal 3, wherein the optimization device 2 is configured to, obtain inventory-data (generally denoted with reference number 11 in FIG. 4) of a plurality of products in a retail store, each product being associated with an expiration period below a threshold. Further, the device 2 determines a priority scheme for said plurality of products, the priority scheme being based upon at least one parameter. Further the device 2, determines at least one product from said priority scheme having a highest priority order. Moreover, the device provides information to (and/or controls, and/or provides information to in order to control and/or provides information to control) a display entity located in said retail store to display graphics emphasizing said at least one product from said priority scheme having the highest priority order and update the priority scheme upon receiving, point-of-sale, POS, data (generally denoted with reference number 11 in FIG. 4) associated with the plurality of products, from said POS terminal.

The optimization device 2 may be configured to assign (see 103′ in FIG. 1) discount prices to at least one of said plurality of products, the discount prices being based on a remaining expiration period.

The optimization device 2 may further be configured to select the at least one parameter is by means of a trained learning algorithm configured to reduce waste in said retail store, further the optimization device may 2, in the step of determining the priority scheme, determine, by means of the trained learning algorithm, the priority scheme for said plurality of products based on the at least one selected parameter. Further, in the step of determining the at least one product, the optimization device 2 may determine, by means of the trained learning algorithm, the at least one product from said priority scheme having the highest priority order.

The optimization device 2 may, upon updating the priority scheme, repeat the step of determining at least one product from said priority scheme having a highest priority order.

The disclosure further relates to a computer program, comprising instructions which, when executed on at least one control circuitry 4, cause the at least one control circuitry 4 to carry out the computer-implemented method 100 according the present disclosure.

1. A computer-implemented method for reducing waste in a retail store, the method comprising:
obtaining inventory-data of a plurality of products in a retail store, each product being associated with an expiration period below a threshold; determining a priority scheme for said plurality of products, the priority scheme being based upon at least one parameter;
determining at least one product from said priority scheme having a highest priority order;
providing information to control a display entity located in said retail store to display graphics emphasizing said at least one product from said priority scheme having the highest priority order; and
updating the priority scheme upon receiving, point-of-sale, POS, data associated with the plurality of products, from a POS terminal.

2. The computer-implemented method according to claim 2, wherein the at least one parameter comprises one or more retail-store related parameters and/or one or more product-related parameters;
wherein the retail-store related parameters comprises at least one of weather data, customer traffic or opening-hours;
wherein product-related parameters comprises at least one of a sales forecast, price, discount, sales history data, price-elasticity and remaining inventory quantity of each product.

3. The computer-implemented method according to claim 1, wherein the step of determining at least one product from said priority scheme having a highest priority order is based upon an additional-sales forecast parameter determined for each product;
the additional-sales forecast parameter determining an additional sales expected from a product, by having said product being graphically emphasized on said display entity during a time period.

4. The computer-implemented method according to claim 1, wherein the method further comprises the step of:
assigning discount prices to at least one of said plurality of products, the discount prices being based on a remaining expiration period.

5. The computer-implemented method according to claim 1, wherein:
the at least one parameter is selected by means of a trained learning algorithm configured to reduce waste in said retail store;
the step of determining the priority scheme comprises, determining, by means of the trained learning algorithm, the priority scheme for said plurality of products based on the at least one selected parameter; and
the step of determining the at least one product comprises, determining, by means of the trained learning algorithm, the at least one product from said priority scheme having the highest priority order.

6. The computer-implemented method according to claim 1, further comprising the step of, upon updating the priority scheme, repeating the step of:
determining at least one product from said priority scheme having a highest priority order.

7. The computer-implemented method according to claim 1, wherein the POS data comprises quantity and identity of products sold at a point in time.

8. An optimization device for reducing waste in a retail store, wherein the optimization device comprises control circuitry, a memory device, an input interface and an output interface, wherein the optimization device is arranged to be connected to a display entity located in said retail store, and a point-of-sale, POS terminal, wherein the optimization device is configured to:
obtain inventory-data of a plurality of products in a retail store, each product being associated with an expiration period below a threshold;
determine a priority scheme for said plurality of products, the priority scheme being based upon at least one parameter;
determine at least one product from said priority scheme having a highest priority order;
provide information to control a display entity located in said retail store to display graphics emphasizing said at least one product from said priority scheme having the highest priority order; and
update the priority scheme upon receiving, point-of-sale, POS, data associated with the plurality of products, from said POS terminal.

9. A system for reducing waste in a retail store, the system comprising:
an optimization device comprising control circuitry, a memory device, an input interface and an output interface;
a display entity located in said retail store; and
a point-of-sale, POS terminal;
wherein the optimization device is configured to:
obtain inventory-data of a plurality of products in a retail store, each product being associated with an expiration period below a threshold;
determine a priority scheme for said plurality of products, the priority scheme being based upon at least one parameter;
determine at least one product from said priority scheme having a highest priority order;
wherein the system is configured to, after determining at least one product from said priority scheme having a highest priority order:
display, at said display entity located in said retail store, graphics emphasizing said at least one product from said priority scheme having the highest priority order; and
update the priority scheme upon receiving, point-of-sale, POS, data associated with the plurality of products, from said POS terminal.

10. A computer program, comprising instructions which, when executed on at least one control circuitry, cause the at least one control circuitry to carry out the computer-implemented method according to claim 1.

11. A carrier containing the computer program according to claim 10, wherein the carrier is one of an electronic signal, optical signal, radio signal, or computer-readable storage medium.

12. The computer-implemented method according to claim 2, wherein the step of determining at least one product from said priority scheme having a highest priority order is based upon an additional-sales forecast parameter determined for each product;
the additional-sales forecast parameter determining an additional sales expected from a product, by having said product being graphically emphasized on said display entity during a time period.

13. The computer-implemented method according to claim 2, wherein the method further comprises the step of:
assigning discount prices to at least one of said plurality of products, the discount prices being based on a remaining expiration period.

14. The computer-implemented method according to claim 3, wherein the method further comprises the step of:
assigning discount prices to at least one of said plurality of products, the discount prices being based on a remaining expiration period.

15. The computer-implemented method according to claim 12, wherein the method further comprises the step of:
assigning discount prices to at least one of said plurality of products, the discount prices being based on a remaining expiration period.

16. The computer-implemented method according to claim 2, wherein:
the at least one parameter is selected by means of a trained learning algorithm configured to reduce waste in said retail store;
the step of determining the priority scheme comprises, determining, by means of the trained learning algorithm, the priority scheme for said plurality of products based on the at least one selected parameter; and
the step of determining the at least one product comprises, determining, by means of the trained learning algorithm, the at least one product from said priority scheme having the highest priority order.

17. The computer-implemented method according to claim 3, wherein:
the at least one parameter is selected by means of a trained learning algorithm configured to reduce waste in said retail store;
the step of determining the priority scheme comprises, determining, by means of the trained learning algorithm, the priority scheme for said plurality of products based on the at least one selected parameter; and
the step of determining the at least one product comprises, determining, by means of the trained learning algorithm, the at least one product from said priority scheme having the highest priority order.

18. The computer-implemented method according to claim 12, wherein:
the at least one parameter is selected by means of a trained learning algorithm configured to reduce waste in said retail store;
the step of determining the priority scheme comprises, determining, by means of the trained learning algorithm, the priority scheme for said plurality of products based on the at least one selected parameter; and
the step of determining the at least one product comprises, determining, by means of the trained learning algorithm, the at least one product from said priority scheme having the highest priority order.

19. The computer-implemented method according to claim 4, wherein:
the at least one parameter is selected by means of a trained learning algorithm configured to reduce waste in said retail store;
the step of determining the priority scheme comprises, determining, by means of the trained learning algorithm, the priority scheme for said plurality of products based on the at least one selected parameter; and
the step of determining the at least one product comprises, determining, by means of the trained learning algorithm, the at least one product from said priority scheme having the highest priority order.

20. The computer-implemented method according to claim 13, wherein:
the at least one parameter is selected by means of a trained learning algorithm configured to reduce waste in said retail store;
the step of determining the priority scheme comprises, determining, by means of the trained learning algorithm, the priority scheme for said plurality of products based on the at least one selected parameter; and
the step of determining the at least one product comprises, determining, by means of the trained learning algorithm, the at least one product from said priority scheme having the highest priority order.
